(19) United States
(12) Patent Application Publication
(10) Pub. No.: US 2026/0188838 A1
(43) Pub. Date: Jul. 2, 2026

(54) COMPOSITE SEPARATOR, MANUFACTURING METHOD THEREOF AND MAGNESIUM SECONDARY BATTERY COMPRISING THE SAME

(71) Applicants: WU LIANG ZHANG, Renton, WA (US); JIAN LIANG CHEN, Seattle, WA (US); JIAN FEI CHEN, Seattle, WA (US); JIAN JIA CHEN, Seattle, WA (US)

(72) Inventors: JIAN LIANG CHEN, Seattle, WA (US); WU LIANG ZHANG, Renton, WA (US)

(21) Appl. No.: 19/002,076

(22) Filed: Dec. 26, 2024

(51) Int. Cl. H01M 50/417; H01M 4/02; H01M 4/134; H01M 4/38; H01M 4/60; H01M 4/62; H01M 10/054; H01M 10/0568; H01M 10/0569; H01M 50/403; H01M 50/426; H01M 50/449; H01M 50/491

(52) U.S. Cl. CPC H01M 50/417; H01M 4/134; H01M 4/381; H01M 4/60; H01M 4/623; H01M 4/625; H01M 10/054; H01M 10/0568; H01M 10/0569; H01M 50/403; H01M 50/426; H01M 50/449; H01M 50/491; H01M 2004/027; H01M 2004/028; H01M 2300/0037

(57) ABSTRACT

A composite separator for a magnesium secondary battery is provided, comprising a polypropylene layer and a modified layer on the polypropylene layer, wherein a material of the modified layer comprises a perfluorosulfonic acid resin composite, and the composite separator has multiple pores having a diameter of 10 nm to 100 nm. The present invention further provides a manufacturing method for the composite separator and a magnesium secondary battery. The composite separator of the present invention adopting PFSA resin composite can prolong battery life and the magnesium secondary battery of the present invention has good battery life and meets commercial standards.

### BACKGROUND

### 1. Field of the Invention

The present invention relates to a composite separator for a magnesium secondary battery.

### 2. Description of the Prior Arts

Lithium-ion secondary batteries have the advantages of high operating voltage, light weight and long battery life, contributing to their wide applications in 3C electronic products.

However, as global capacity for lithium metal production may be insufficient to meet commercial needs for the battery industry, magnesium secondary batteries become the top candidate for the following advantages: (1) Magnesium is earth-abundant and inexpensive; (2) Magnesium batteries shall have a better performance resulting from both a theoretical specific capacity and a theoretical energy density higher than those of lithium batteries; and (3) Magnesium batteries can be safer and less likely to explode because dendrites are not formed on the magnesium foil of anode.

Further, batteries with longer battery life are beneficial to consumers and eco-friendliers. Therefore, a magnesium battery with prolonged battery life is in great need.

### SUMMARY OF THE INVENTION

To reach the aforementioned object, the present invention provides a composite separator for a magnesium secondary battery, comprising a polypropylene layer and a modified layer on the polypropylene layer, wherein a material of the modified layer comprises a perfluorosulfonic acid (PFSA) resin composite, and the composite separator has multiple pores having a diameter of nm to 100 nm.

6 The cathode of the magnesium secondary battery of the present invention comprises pyrene-4,5,9,10-tetraone (PTO) and the anode comprises a magnesium foil. During battery charging, PTO (slightly soluble) in the cathode receives electrons and captures magnesium ions to form Mg₁PTO (soluble) and Mg₂PTO (insoluble). As the migration of soluble Mg₁PTO from the cathode into the anode will result in gradual loss of both cathodes and anodes, the composite separator of the present invention adopts PFSA resin composite, which provides negatively charged sulfonate group (—SO₃⁻) to restrict the migration of Mg₁PTO comprising PTO²⁻ and allows magnesium ions migration, so that both cathodes (comprising PTO) and anodes (comprising magnesium foil) can be well protected during battery charging to achieve prolonged battery life.

In one embodiment, the PFSA resin composite is PFSA/polytetrafluoroethylene (PTFE) copolymer.

In one embodiment, the polypropylene layer is a polypropylene monolayer membrane.

In one embodiment, based on the modified layer, the PFSA resin composite has an area density of 0.15 mg/cm² to 0.25 mg/cm². Preferably, the PFSA resin composite has an area density of 0.18 mg/cm² to 0.22 mg/cm².

In one embodiment, the modified layer has a thickness of 1 μm to 3 μm. Preferably, the modified layer has a thickness of 1.8 μm to 2.2 μm.

In one embodiment, the polypropylene layer has a thickness of 20 μm to 30 μm. Preferably, the polypropylene layer has a thickness of 23 μm to 27 μm.

In one embodiment, the modified layer of the composite separator has multiple pores having a diameter of 10 nm to 100 nm.

In one embodiment, the polypropylene layer of the composite separator has multiple pores having a diameter of 10 nm to 100 nm.

The present invention further provides a manufacturing method for the composite separator for a magnesium secondary battery, comprising providing a solution comprising the PFSA resin composite on the polypropylene layer to obtain a wet layer, and drying the wet layer into the modified layer and obtaining the composite separator.

In one embodiment, the solution comprising the PFSA resin composite is D520 Nafion Dispersion. Preferably, the D520 Nafion Dispersion is D520 Nafion Dispersion-Alcohol based 1000 EW at 5 wt %.

In one embodiment, the D520 Nafion Dispersion has a specific gravity of 0.92 to 0.94.

In one embodiment, the D520 Nafion Dispersion has a viscosity of 10 cp to 40 cp at 25° C. with a shear rate of 40 sec⁻¹.

In one embodiment, the polypropylene layer has a porosity of 35% to 45%. Preferably, the polypropylene layer has a porosity of 40% to 42%.

The present invention further provides a magnesium secondary battery, comprising a cathode, an anode, an electrolyte and the composite separator, wherein the composite separator is interposed between the cathode and the anode, the electrolyte is in contact with the cathode and the anode, and the modified layer of the composite separator faces the cathode.

In one embodiment, the cathode comprises pyrene-4,5,9,10-tetraone (PTO).

In one embodiment, based on the cathode, the PTO has an area density of 2 mg/cm² to 3 mg/cm². Preferably, the PTO has an area density of 2.3 mg/cm² to 2.7 mg/cm².

In one embodiment, the cathode comprises PTO, carbon black and a binder, and based on the total weight of the cathode, the PTO is in an amount of 25 weight percent to 35 weight percent, the carbon black is in an amount of 45 weight percent to 55 weight percent, and the binder is in an amount of 15 weight percent to 25 weight percent. Preferably, based on the total weight of the cathode, the PTO is in an amount of 28 weight percent to 32 weight percent, the carbon black is in an amount of 48 weight percent to 52 weight percent, and the binder is in an amount of 18 weight percent to 22 weight percent.

In one embodiment, the carbon black is Ketjenblack carbon (KB). Preferably, the carbon black is Ketjenblack carbon ECP-600JD.

In one embodiment, the carbon black has an average diameter of less than or equal to 75 μm. Preferably, the carbon black has an average diameter of less than or equal to 45 μm. More preferably, the carbon black has an average diameter of less than or equal to 45 μm and greater than 38 μm.

According to the present invention, more than 98% of the carbon black can pass through the sieve with 200 mesh, which corresponds to a particle diameter of 75 μm, and more than 80% of the carbon black can pass through the sieve with 325 mesh, which corresponds to a particle diameter of 45 μm.

In one embodiment, the carbon black has a total porosity of 400 ml/100 g to 550 ml/100 g. Preferably, the carbon black has a total porosity of 440 ml/100 g to 510 ml/100 g.

In one embodiment, the carbon black has an apparent density of 15 g/cm³ to 55 g/cm³. Preferably, the carbon black has an apparent density of 17 g/cm³ to 50 g/cm³.

In one embodiment, the binder comprises polytetrafluoroethylene (PTFE). Preferably, the binder is a PTFE powder. More preferably, the PTFE powder is MSK-PTFE-F104.

In one embodiment, the PTFE powder has a diameter of 450 μm to 550 μm. Preferably, the PTFE powder has a diameter of 490 μm to 510 μm. More preferably, said diameter is obtained according to ASTM D1457 standard.

In one embodiment, the PTFE powder has an apparent density of 400 g/L to 500 g/L. Preferably, the PTFE powder has an apparent density of 440 g/L to 460 g/L. More preferably, said apparent density is obtained according to ASTM D1457 standard.

In one embodiment, the PTFE powder has a melting point of 320° C. to 330° C. Preferably, the PTFE powder has a melting point of 325° C. to 329° C. More preferably, said melting point is obtained according to ASTM D1457 standard.

In one embodiment, the PTFE powder has a specific weight of 1.9 to 2.5. Preferably, the PTFE powder has a specific weight of 2.1 to 2.25. More preferably, said specific weight is obtained according to ASTM D1457 standard.

In one embodiment, the PTFE powder has a tensile strength of greater than 15 MPa. Preferably, the PTFE powder has a tensile strength of greater than 19 MPa and less than 25 MPa. More preferably, said tensile strength is obtained according to JIS K6891 standard.

In one embodiment, the PTFE powder has an elongation of greater than 300%. Preferably, the PTFE powder has an elongation of greater than 320% and less than 350%. More preferably, said elongation is obtained according to JIS K6891 standard.

In one embodiment, the PTFE powder has a compression ratio of less than 550. Preferably, the PTFE powder has a compression ratio of less than 510 and greater than 450.

In one embodiment, the anode comprises a magnesium foil.

In one embodiment, the electrolyte comprises Mg (CB₁₁H₁₂)₂ (abbreviated as MMC) and a solvent. Preferably, the electrolyte is MMC with a concentration of 0.4 mol/kg to 0.6 mol/kg in a solvent. More preferably, the electrolyte is MMC with a concentration of 0.5 mol/kg in a solvent.

In one embodiment, the solvent comprises 1,2-dimethoxyethane (DME), diglyme (abbreviated as G2), tetraglyme (abbreviated as G4), tetrahydrofuran (THF), 1,3-dioxolane (DOL) or a combination thereof.

In one embodiment, the solvent comprises a binary mixture.

In one embodiment, the solvent comprises a binary mixture of DME and G2, DOL and DME, DOL and G2, THF and G2, or THF and DME. Preferably, based on the total weight of the binary mixture, both ingredients of the binary mixture are in an amount of 40 weight percent to 60 weight percent. More preferably, based on the total weight of the binary mixture, both ingredients of the binary mixture are in an amount of 48 weight percent to 52 weight percent.

In one embodiment, the binary mixture comprises 1,2-dimethoxyethane (DME) and diglyme (abbreviated as G2). Preferably, based on the total weight of the binary mixture, DME is in an amount of 40 weight percent to 60 weight percent, and G2 is in an amount of 40 weight percent to 60 weight percent. More preferably, based on the total weight of the binary mixture, DME is in an amount of 48 weight percent to 52 weight percent, and G2 is in an amount of 48 weight percent to 52 weight percent. In one embodiment, the electrolyte is MMC with a concentration of 0.5 mol/kg in a binary mixture of DME and G2, and based on the total weight of the binary mixture, both DME and G2 are in an amount of 50 weight percent.

In one embodiment, the electrolyte comprises Mg (CB₁₁H₁₂)₂ and tetraglyme. Preferably, the electrolyte is Mg (CB₁₁H₁₂)₂ with a concentration of 0.4 mol/kg to 0.6 mol/kg in tetraglyme. More preferably, the electrolyte is Mg (CB₁₁H₁₂)₂ with a concentration of 0.5 mol/kg in tetraglyme (abbreviated as MMC/G4).

In one embodiment, the magnesium secondary battery has a voltage of 2.1V.

In one embodiment, the magnesium secondary battery comprises a button, cylindrical, prismatic or pouch cell battery.

To sum up, the composite separator for a magnesium secondary battery of the present invention adopting PFSA resin composite can prolong battery life. The magnesium secondary battery of the present invention has the advantages of high operating voltage, light weight and long battery life, and meets commercial standards.

### BRIEF DESCRIPTION OF THE DRAWING

FIG. 1 is a schematic diagram of the composite separator of Example 1 for a magnesium secondary battery.

### DETAILED DESCRIPTION OF THE PREFERRED EMBODIMENTS

The present invention is further explained through the following embodiments. A person having ordinary skill in the art can easily understand the advantages and efficacies achieved by the present invention. The present invention should not be limited to the contents of the embodiments. A person having ordinary skill in the art can make some improvement or modifications which are not departing from the spirit and scope of the present invention to practice or apply the content of the present invention.

### Example 1: Composite Separator for Magnesium Secondary Battery

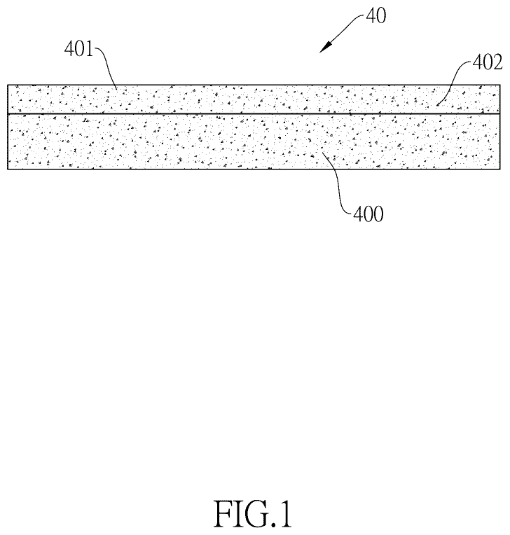

As shown in FIG. 1, the composite separator 40 for a magnesium secondary battery comprises a polypropylene layer 400 and a modified layer 401 on the polypropylene layer 400, wherein a material of the modified layer 401 comprises a perfluorosulfonic acid (PFSA) resin composite, and the composite separator 40 has multiple pores 402 having a diameter of 10 nm to 100 nm.

Further, the composite separator for a magnesium secondary battery (abbreviated as the composite separator of E1) of the present invention was prepared as follows: providing a solution comprising the PFSA resin composite on the polypropylene layer to obtain a wet layer, and drying the wet layer into the modified layer and obtaining the composite separator.

Specifically, the solution comprising the PFSA resin composite was applied to a surface of the polypropylene layer by a scraper to obtain a wet layer with an areal mass loading of PFSA resin composite as 0.2 mg/cm² on the polypropylene layer, and the wet layer on the polypropylene layer was dried at 60° C. by an oven to obtain the modified layer with an area density of PFSA resin composite as 0.2 mg/cm² on the polypropylene layer, which was the composite separator of the present invention. Further, the modified layer has multiple pores having a diameter of 10 nm to 100 nm.

The polypropylene layer had a diameter of 16 mm and was cut from a polypropylene monolayer membrane, which was a 25 μm-thick monolayer microporous membrane (PP) and the pore diameter thereof was 10 nm to 100 nm. The polypropylene monolayer membrane was produced in the conventional wet process, which involved extrusion of a plasticizer/polymer mixture at elevated temperature, followed by phase separation, biaxial stretching, and extraction of the plasticizer (the pore former).

The solution comprising the PFSA resin composite is D520 Nafion Dispersion—Alcohol based 1000 EW at 5 wt %, which was made from chemically stabilized perfluorosulfonic acid (PFSA)/polytetrafluoroethylene (PTFE) copolymer in the acid (H⁺) form.

Finally, the composite separator has multiple pores having a diameter of 10 nm to 100 nm.

### Example 2: Magnesium Secondary Battery

The magnesium secondary battery of Example 2 of the present invention comprises a cathode, an anode, an electrolyte and the composite separator, wherein the composite separator is interposed between the cathode and the anode, the electrolyte is in contact with the cathode and the anode, and the modified layer of the composite separator faces the cathode. Specifically, the magnesium secondary battery was a CR2032 button cell battery.

The magnesium secondary battery of Example 2 (E2) was prepared as follows:

First, the cathode was prepared as follows: Pyrene-4,5,9,10-tetraone (PTO), carbon black and a binder with a weight ratio of 3:5:2 were added into absolute ethanol and mixed by S-450D BRANSON sonifier for at least 30 17 minutes to obtain a cathode mixture. The cathode mixture was further molded, pressed and dried under vacuum at 80° C. for 24 hours to obtain an independent electrode with a diameter of 15 mm, which was the cathode, wherein the PTO in the cathode (after drying) had an area density of about 2.5 mg/cm².

The carbon black was Ketjenblack carbon ECP-600JD, which had a total porosity of 440 ml/100 g to 510 ml/100 g and an apparent density of 17 g/cm³ to 50 g/cm³. Further, more than 98% of the Ketjenblack carbon ECP-600JD can pass through the sieve with 200 mesh, and more than 80% of the Ketjenblack carbon ECP-600JD can pass through the sieve with 325 mesh.

The binder was MSK-PTFE-F104, which was a polytetrafluoroethylene (PTFE) powder, and had a diameter of 500 μm according to ASTM D1457 standard, an apparent density of 450 g/L according to ASTM D1457 standard, a melting point of 326° C. to 328° C. according to ASTM D1457 standard, a specific weight of 2.14 to 2.2 according to ASTM D1457 standard, a tensile strength of greater than 19.6 MPa according to JIS K6891 standard, an elongation of greater than 330% according to JIS K6891 standard, and a compression ratio of less than 500.

Second, the anode was prepared as follows: A high-purity magnesium foil (99.95%) was polished with sandpaper (#300) to remove oxides on the surface thereof to obtain the anode with a thickness of 100 μm and a diameter of 14 mm. Further, the anode was stored in nitrogen gas before use.

Third, the electrolyte was Mg (CB₁₁H₁₂)₂ (abbreviated as MMC) with a concentration of 0.5 mol/kg in a binary mixture of 1,2-dimethoxyethane (DME) and diglyme (abbreviated as G2), and based on the total weight of the binary mixture, both DME and G2 were in an amount of 50 weight percent. Said electrolyte was abbreviated as “MMC/(DME-G2) electrolyte”.

Fourth, the cathode was fixed in a cathode case with a conductive glue to obtain a cathode case with the cathode. The MMC/(DME-G2) electrolyte was filled in the cathode case with the cathode, and then the composite separator of E1 with the modified layer facing the cathode was fixed to the inner peripheral wall of the cathode case by glue to obtain a sealed cathode case and to prevent leakage. The anode was fixed in an anode case with a conductive glue to obtain an anode case with the anode. The MMC/(DME-G2) electrolyte was filled in the anode case with the anode to obtain an anode case with the anode and electrolytes, and the sealed cathode case was fixed to the anode case with the anode and electrolytes to obtain the magnesium secondary battery.

Finally, the magnesium secondary battery of E2 had a voltage of 2.1V, the cathode had a specific capacity of 307 mAh/g at the 1 C Rate for charging and discharging, wherein the cathode comprising PTO had a theoretical specific capacity of 408 mAh/g.
Test: Repeated battery cycling (charge/discharge) test

This test compared the battery lives of magnesium secondary batteries using different separators, and comprised three groups as follows:
(1) the magnesium secondary battery of Example 2 (E2);
(2) the magnesium secondary battery of Comparative Example 1 (CE1): CE1 was similar to E2, and the difference was that the separator of CE1 was Celgard® 2400 monolayer membrane, not the composite separator of E1. Further, the pore diameter of Celgard® 2400 monolayer membrane was 0.1 μm to 0.3 μm, not 10 nm to 100 nm; and
(3) the magnesium secondary battery of Comparative Example 2 (CE2): CE2 was similar to E2, and the difference was that the separator of CE2 was a graphene-PP separator which was prepared as follows: a graphene solution (CAS #: 7782-42-5, purchased from ACS Material) was applied to a surface of the Celgard® 2400 monolayer membrane by a scraper and dried at 80° C. by an oven to obtain the graphene-PP separator, wherein the graphene (after drying) in the modified layer had an area density of 0.48 mg/cm², and the graphene-PP separator had multiple pores having a diameter of 0.1 μm to 0.3 μm.

The repeated battery cycling (charge/discharge) test was carried out by a battery charge and discharge testing equipment (BT-2018R, LANBTS) at 25° C. For battery discharge, all groups adopted the same discharge rate at the 1 C Rate and the battery discharge process ended upon the battery voltage reduced to 0.9 V. For battery charge, all groups adopted the same charge rate at the 5 C Rate and the battery charge process ended upon the battery voltage reached 2.1 V.

The capacity of the battery was measured at 20th, 50th, 100th, 200th, 300th, 400th and 500th charging cycles and was compared with the initial capacity of the battery. If the capacity of battery drops to 80% of the initial capacity for two consecutive charging cycles, the total number of charge and discharge cycle was recorded. Further, if the number of charge and discharge cycle reached 500 cycles, while the capacity of the battery was kept at more than 80% of the initial capacity, the result was recorded as ≥500, indicating that such battery met commercial use standard.

The results of the repeated battery cycling (charge/discharge) test of all groups were shown in Table 1.

TABLE 1
the results of the repeated battery cycling
(charge/discharge) test of all groups

| Group | E2 | CE1 | CE2 |
|---|---|---|---|
| charge/discharge cycling (cycles) | ≥500 | 200 | 20 |
| Capacity of battery compared to the | ≥80% | 80% | 60% |
| initial capacity (%) | | | |

According to Table 1, the magnesium secondary battery of E2 had more than 80% capacity of battery compared to the initial capacity after 500 cycles of charge/discharge cycling, and met commercial use standard. Therefore, in comparison with CE1 and CE2, adopting the composite separator of E1 can greatly prolong the battery life of the magnesium secondary battery.

What is claimed is:

1. A composite separator for a magnesium secondary battery, comprising a polypropylene layer and a modified layer on the polypropylene layer, wherein a material of the modified layer comprises a perfluorosulfonic acid (PFSA) resin composite, and the composite separator has multiple pores having a diameter of 10 nm to 100 nm.

2. The composite separator as claimed in claim 1, wherein based on the modified layer, the PFSA resin composite has an area density of 0.15 mg/cm² to 0.25 mg/cm².

3. The composite separator as claimed in claim 1, wherein the PFSA resin composite is PFSA/polytetrafluoroethylene (PTFE) copolymer.

4. The composite separator as claimed in claim 1, wherein the polypropylene layer has a thickness of 20 μm to 30 μm.

5. The composite separator as claimed in claim 1, wherein the modified layer has a thickness of 1 μm to 3 μm.

6. The composite separator as claimed in claim 1, wherein the polypropylene layer has multiple pores having a diameter of 10 nm to 100 nm, and the modified layer has multiple pores having a diameter of 10 nm to 100 nm.

7. A manufacturing method for the composite separator for a magnesium secondary battery as claimed in claim 1, comprising:
providing a solution comprising the PFSA resin composite on the polypropylene layer to obtain a wet layer; and
drying the wet layer into the modified layer and obtaining the composite separator.

8. A magnesium secondary battery, comprising a cathode, an anode, an electrolyte and the composite separator as claimed in claim 1, wherein the composite separator is interposed between the cathode and the anode, the electrolyte is in contact with the cathode and the anode, and the modified layer of the composite separator faces the cathode.

9. The magnesium secondary battery as claimed in claim 8, wherein the cathode comprises pyrene-4,5,9,10-tetraone (PTO).

10. The magnesium secondary battery as claimed in claim 9, wherein based on the cathode, the PTO has an area density of 2 mg/cm² to 3 mg/cm².

11. The magnesium secondary battery as claimed in claim 9, wherein the cathode comprises PTO, carbon black and a binder, and based on the total weight of the cathode, the PTO is in an amount of 25 weight percent to 35 weight percent, the carbon black is in an amount of 45 weight percent to 55 weight percent, and the binder is in an amount of 15 weight percent to 25 weight percent.

12. The magnesium secondary battery as claimed in claim 8, wherein the binder comprises polytetrafluoroethylene (PTFE).

13. The magnesium secondary battery as claimed in claim 8, wherein the anode comprises a magnesium foil.

14. The magnesium secondary battery as claimed in claim 8, wherein the electrolyte comprises Mg (CB₁₁H₁₂)₂ and a solvent.

15. The magnesium secondary battery as claimed in claim 14, wherein the solvent comprises 1,2-dimethoxyethane, diglyme, tetraglyme, tetrahydrofuran, 1,3-dioxolane or a combination thereof.

16. The magnesium secondary battery as claimed in claim 15, wherein the electrolyte is Mg (CB₁₁H₁₂)₂ with a concentration of 0.4 mol/kg to 0.6 mol/kg in the solvent.

17. The magnesium secondary battery as claimed in claim 16, wherein the solvent comprises a binary mixture.

18. The magnesium secondary battery as claimed in claim 17, wherein the binary mixture comprises 1,2-dimethoxyethane and diglyme, and based on the total weight of the binary mixture, 1,2-dimethoxyethane is in an amount of 40 weight percent to 60 weight percent, and diglyme is in an amount of 40 weight percent to 60 weight percent.
